(19) United States
(12) Patent Application Publication
(10) Pub. No.: US 2008/0155336 A1
(43) Pub. Date: Jun. 26, 2008

(54) METHOD, SYSTEM AND PROGRAM PRODUCT FOR DYNAMICALLY IDENTIFYING COMPONENTS CONTRIBUTING TO SERVICE DEGRADATION

(75) Inventors: Niraj P. Joshi, Cary, NC (US); Kenneth J. Parzygnat, Apex, NC (US); Wayne B. Riley, Cary, NC (US)

Correspondence Address: SILVY ANNA MURPHY, 100 TURNBERRY LANE, CARY, NC, 27518, US

(73) Assignee: International Business Machines Corporation, Armonk, NY (US)

(21) Appl. No.: 11/613,438

(22) Filed: Dec. 20, 2006

(51) Int. Cl. G06F 11/28

(52) U.S. Cl. 714/37; 714/E11.178

(57) ABSTRACT

A method, system and program product for dynamically identifying one or more components or resources contributing to a service degradation is provided. The method includes providing a dynamic correlation logic tool having logic that is configured to dynamically build a model for an application experiencing a service degradation at a given point-in-time. Further, the method includes obtaining from a configuration management database configuration data for resources utilized by the application experiencing the service degradation at that point-in-time and dynamically building the model using the configuration data obtained and status data obtained from monitoring sources that monitor the resources. Further, the method includes evaluating and analyzing the model, using the logic provided, and identifying one or more resources utilized by the application contributing to the service degradation. The method further includes reporting the one or more resources identified, such that, appropriate action(s) can be taken.

### FIELD OF THE INVENTION

The present invention relates to a method, system and computer program product for dynamically identifying one or more components contributing to a resource or service degradation. In particular, the present invention relates to a method, system and computer program product for dynamically identifying one or more components utilized by an application contributing to a resource or service degradation at a given point-in-time, using logic to evaluate and analyze configuration data obtained from a configuration management database in conjunction with information acquired from one or more monitoring systems for resources utilized by an application experiencing the resource or service degradation.

### BACKGROUND OF THE INVENTION

Businesses, in particular, Information Technology (IT) organizations within businesses are constantly facing more complex heterogeneous environments where identification of which component or components, in the enterprise are causing or contributing to a service disruption or resource unavailability is increasing in difficulty and complexity. Identification of the correct component or components causing the service or availability disruption is critical to being able to focus the necessary IT talents and resources to resolve the service disruption. Efforts spent trying to resolve service disruptions that address the wrong IT components result in wasted time and money and can actually increase the impact being felt by a disruption. As such, there is a need for a business and/or an IT organization to provide a cost-effective way to develop ways to identify the correct components that are causing or contributing to a service disruption or resource unavailability.

### SUMMARY OF THE INVENTION

In a first aspect of the invention, there is provided a method of dynamically identifying one or more components contributing to a service degradation at a given point-in-time. The method includes obtaining from a configuration management database a set of configuration data for one or more components utilized by an application experiencing a service degradation at a given point-in-time and dynamically building a model using the set of configuration data obtained from the configuration management database and status data obtained from one or more monitoring sources configured to monitor the one or more components. Further, the method includes evaluating the model using logic and identifying the one or more components utilized by the application contributing to the service degradation at the given point-in-time. The method further includes reporting the one or more components identified, such that, an appropriate action can be taken with respect to the one or more components contributing to the service degradation at the given point-in-time. The obtaining step includes providing the configuration management database configured to store therein the set of configuration data for the one or more components utilized by the application. Further, in an embodiment, the dynamically building step includes providing a dynamic correlation logic tool having logic that is configured to dynamically build the model for the application experiencing service degradation and to analyze the model using the logic. Furthermore, the dynamically building step includes acquiring from the one or more monitoring sources a current status for the one or more components utilized by the application for dynamically building the model. In an embodiment, the obtaining step further includes providing the configuration management database configured to update the set of configuration data stored therein on a predetermined basis, such that the set of configuration data for the one or more components utilized by the application experiencing the service degradation at the given point-in-time obtained by the dynamic correlation logic tool is an up-to-date set of configuration data. In an embodiment, the acquiring step further includes determining the one or more monitoring sources configured to monitor the one or more components that are utilized by the application experiencing the service degradation at the given point-in-time. In an embodiment, the set of configuration data includes one or more of: types of components, component relationships, types of relationships, attributes for each component and attributes for each relationship.

In another aspect of the invention, there is provided a system for dynamically identifying one or more resources contributing to a service degradation at a given point-in-time. The system includes an application experiencing a service degradation at a given point-in-time, the application utilizing one or more resources. Further, the system includes a configuration management database configured to store therein a set of configuration data for the one or more resources utilized by the application and a dynamic correlation logic tool having logic, the dynamic correlation logic tool being configured to dynamically build a model using the set of configuration data obtained from the configuration management database and using status information for the one or more resources obtained from one or more monitoring systems configured to monitor the one or more resources for the application experiencing the service degradation at the given point-in-time and is configured to analyze the model using the logic to dynamically identify the one or more resources contributing to the service degradation at the given point-in-time, such that, appropriate action can be taken with respect to the one or more resources identified. In an embodiment, the dynamic correlation logic tool is further configured to obtain from the one or more monitoring systems, as needed, a current status for the one or more resources in order to build the model. In an embodiment, the configuration management database is further configured to update on a predetermined basis the set of configuration data for the one or more resources utilized by the application. Further, the dynamic correlation logic tool is further configured to use the set of configuration data that is updated in the configuration management database, such that the set of configuration data used by the dynamic correlation logic tool to build the model is an up-to-date set of configuration data. Further, in an embodiment, the dynamic correlation logic tool is configured to dynamically build the model using the up-to-date set of configuration data obtained from the configuration management database and the current status for the one or more resources obtained from the one or more monitoring systems. In an embodiment, the set of configuration data includes one or more of: types of resources, resource relationships, types of relationships, attributes for each resource and attributes for each relationship.

In yet another aspect of the invention, there is provided a computer program product for dynamically identifying one or more resources contributing to a service degradation at a given point-in-time. The computer program product includes a computer readable medium and first program instructions to obtain from a configuration management database a set of configuration data for one or more resources utilized by an application experiencing a service degradation at a given point-in-time. The computer program product further includes second program instructions to dynamically build a model using the set of configuration data obtained from the configuration management database and status data obtained from one or more monitoring sources configured to monitor the one or more resources and third program instructions to evaluate the model to identify the one or more resources utilized by the application contributing to the service degradation at the given point-in-time. In an embodiment, the first program instructions further include instructions to provide the configuration management database configured to store therein the set of configuration data for the one or more resources utilized by the application and configured to update the set of configuration data stored therein on a predetermined basis, such that the set of configuration data for the one or more resources utilized by the application experiencing the service degradation at the given point-in-time stored in the configuration management database includes an up-to-date set of configuration data. Further, in an embodiment, the second program instructions include instructions to acquire from the one or more monitoring sources, as needed, a current status for the one or more resources utilized by the application to dynamically build the model. Furthermore, the second program instructions include instructions to dynamically build the model using the up-to-date set of configuration data obtained from the configuration management database and the current status acquired for the one or more resources from the one or more monitoring sources. In an embodiment, the third program instructions include instructions to report the one or more resources identified, such that, an appropriate action can be taken with respect to the one or more resources contributing to the service degradation at the given point-in-time. In an embodiment, the set of configuration data includes one or more of: types of resources, resource relationships, types of relationships, attributes for each resource and attributes for each relationship. Preferably, each of the first, second and third program instructions are stored on the computer readable medium.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a flowchart outlining the steps involved in dynamically identifying one or more resources or components contributing to a resource or service degradation at a given point-in-time, in accordance with an embodiment of the present invention.

FIG. 2 depicts an example of the configuration data or information stored in a configuration management database that is utilized by an application experiencing a resource or service degradation at a given point-in-time that is used to dynamically identify one or more resources or components contributing to the resource or service degradation at the given point-in-time, in accordance with an embodiment of the present invention

FIG. 3 is a schematic block system diagram illustrating an embodiment of a system for dynamically identifying one or more resources or components contributing to a resource or service degradation at a given point-in-time, in accordance with an embodiment of the present invention.

FIG. 4 is a schematic block system diagram illustrating an embodiment of a computer infrastructure for dynamically identifying one or more resources or components contributing to a resource or service degradation at a given point-in-time, in accordance with an embodiment of the present invention.

### BEST MODE FOR CARRYING OUT THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network.

Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

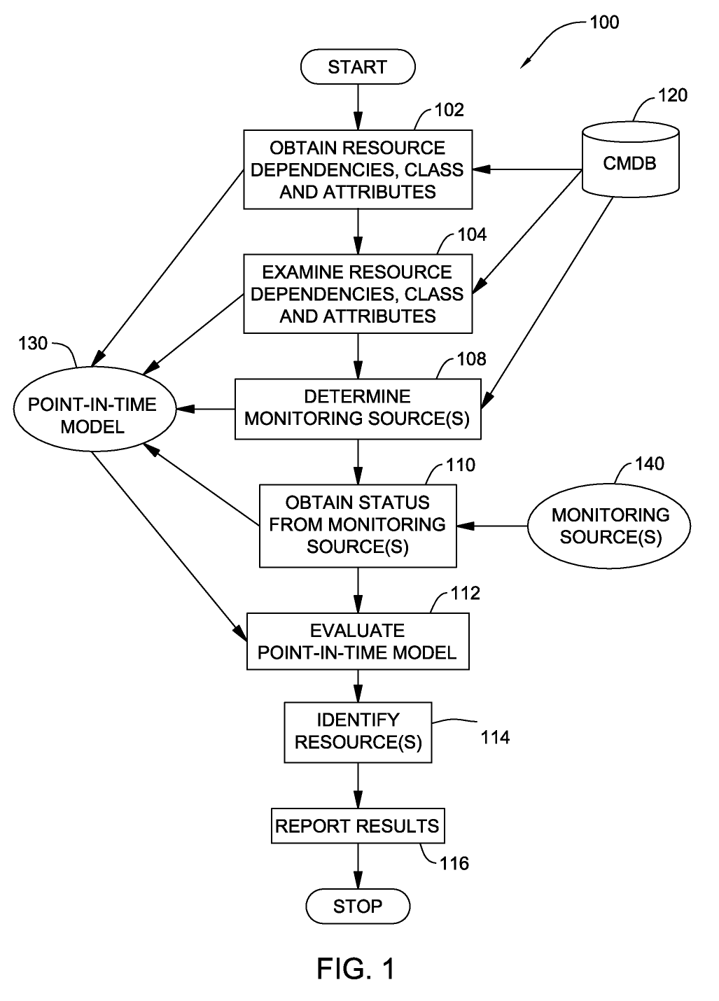

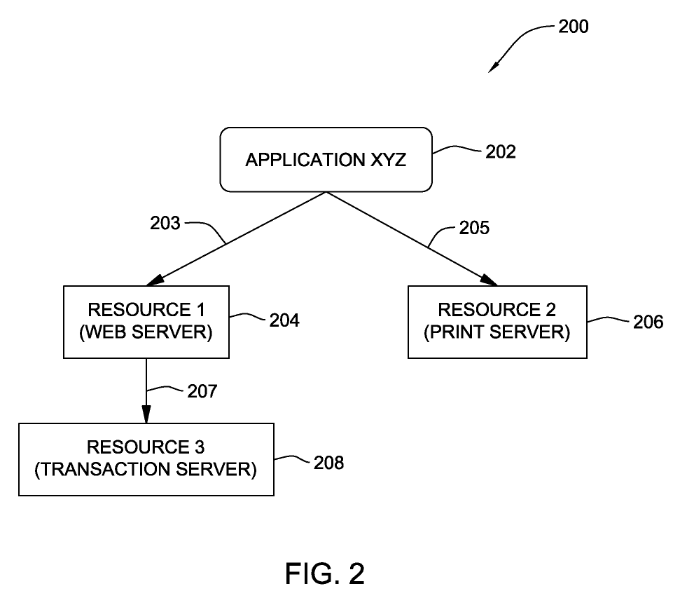

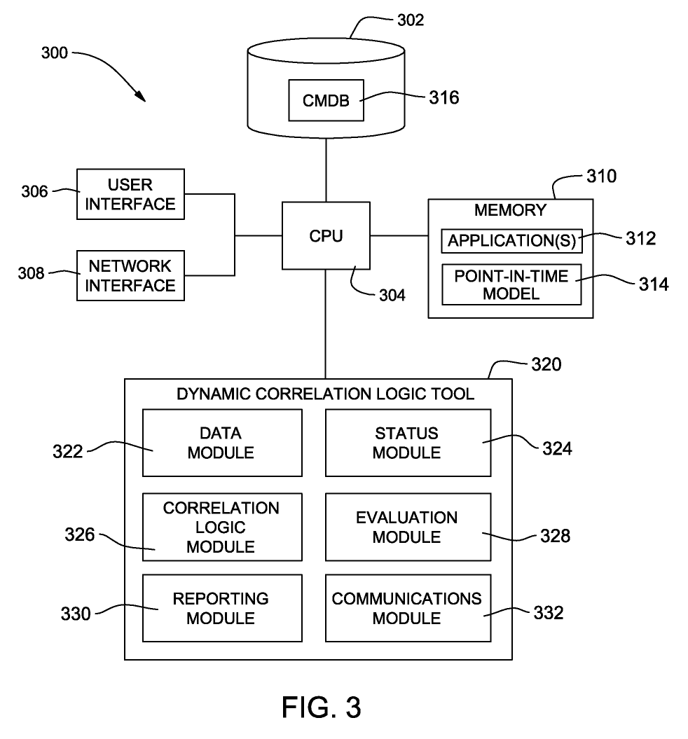

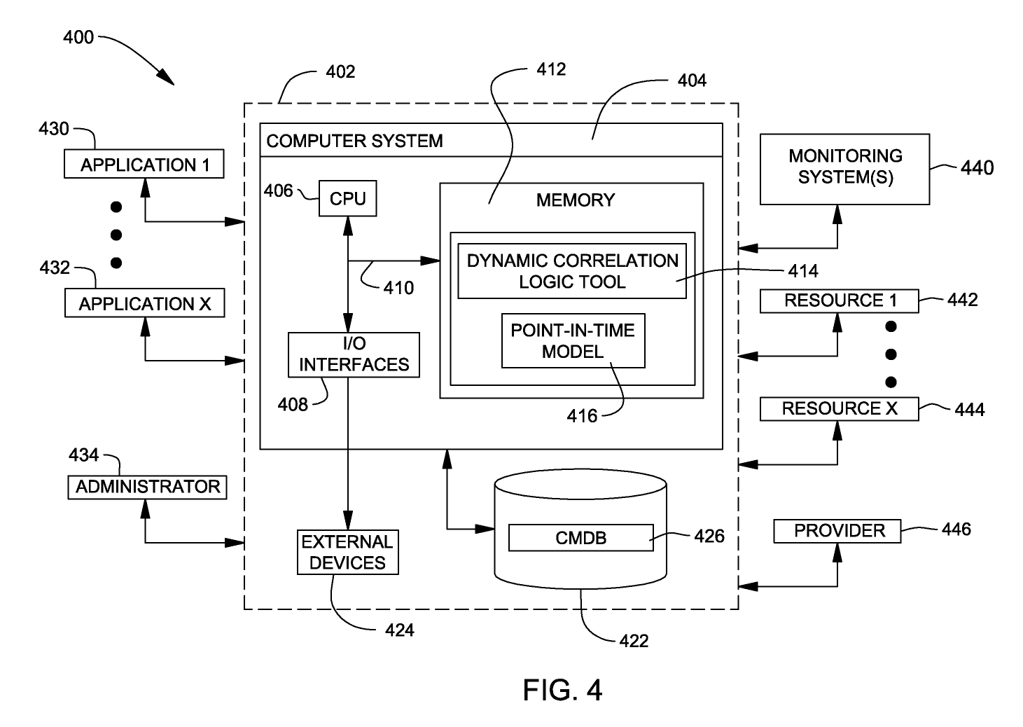

In one embodiment, the invention provides a method for dynamically identifying one or more components contributing to a resource or service degradation at a given point-in-time. In particular, in an embodiment, the invention provides a method of identifying a component or components utilized by an application that are actually responsible for causing a service disruption by correlating the resources and relationships contained in a dynamically changing database with information obtained from one or more monitoring systems for those resources using a dynamic correlation logic tool, as described further herein with respect to FIGS. 3 and 4. The dynamic correlation logic tool contains the correlation rules or logic or rules used to process or analyze or correlate a set of configuration data (the resources, the relationships, the types of resources—as explained herein below and with respect to FIG. 2) and monitored or status data for the resources, for instance, the current status obtained from the one or more monitoring sources or systems. Turning to FIG. 1, reference numeral 100, in step 102, the method comprises obtaining from a configuration management database 120 a set of configuration data for the one or more resources utilized by an application experiencing a resource or service degradation at a given point-in-time. In an embodiment, the configuration management database 120 is configured to store dynamically changing configuration data or information for resources that are utilized by an application, which includes their relationships or dependencies as well, that is, the relationship of one resource to another and the relationship of the resource(s) to the application. Further, in step 104, each object in the configuration management database 120 representing a resource or relationship is examined. For instance, the configuration data obtained in step 102 from the configuration management database 120 that is examined in step 104 include resource types or class information, resource relationships, types of relationships, attributes of resources and attributes of relationships. For instance, the resource type may indicate that a resource is typed or classified as a web server or a print server, etc. Similarly, the resource relationship for a resource may indicate whether there is a direct relationship between an application and a resource or whether there is an indirect relationship between an application and a resource. Further, the type of relationship may indicate whether an application runs on a resource or whether an application depends on a resource or whether a resource depends on another resource, etc. Additionally, the configuration data obtained in step 102 from the configuration management database 120 may include examining attributes for resources and attributes for relationships, such as, date of last change for a resource, etc. may be utilized in the determination or identification of failing components or components causing a service degradation at a given point-in-time. It is understood that other user specified object (representing a resource or relationship) attributes could be examined or interrogated in the correlation method or process. Furthermore, the resource and relationship information utilized by an application stored in the configuration management database 120 is adjusted as a business or enterprise environment evolves and grows, thus, reflecting recent or up-to-date changes in the resources and their relationships that are stored therein. Moreover, in step 108 a determination is made as to the monitoring systems or sources that monitor the resources associated with or utilized by the application experiencing the resource or service degradation at the given point-in-time. In particular, in step 110, monitored status data or status is obtained or acquired for one or more resources utilized by an application from the monitoring sources or systems 140 determined in step 108. In an embodiment, a current or point-in-time status is obtained for a resource monitored by a monitoring source or system 140, as needed, in order to identify the one or more resources contributing to the resource or service degradation at the given point-in-time. Accordingly, a point-in-time model or analysis model or model 130 is dynamically built or created from all the data or information gathered from steps 102 through 110, namely, from using the set of configuration data obtained from the configuration management database and the current status or monitored status data obtained from the one or more monitoring sources monitoring the one or more components or resources utilized by the application, plus any additional attributes for the resources and/or relationships, as described hereinabove. The point-in-time model 130 created is evaluated or analyzed in step 112 using the logic provided in the dynamic correlation logic tool in order to identify the one or more components or resources utilized by the application contributing to the resource or service degradation at the given point-in-time. The component or components responsible for the resource or service degradation at the given point-in-time are identified in step 114. The method further comprises reporting, in step 116, the one or more components identified, such that, an appropriate action can be taken, for instance, by an administrator, with respect to the one or more components contributing to the resource or service degradation at the given point-in-time, ending the process. For instance, after an identification of the failing component or components is made, a report containing the analysis of the data could be produced and sent to an administrator or a report could be produced on a screen for an administrator's use or, alternatively, a notification, such as, an e-mail containing the report could be sent to an administrator.

Turning to FIG. 2, reference numeral 200 depicts an example of the configuration data or information (representing the dependency and resource relationships utilized by application XYZ, reference numeral 202, experiencing a resource or service degradation at a given point-in-time) stored in a configuration management database that is used to dynamically identify one or more resources or components contributing to the resource or service degradation at the given point-in-time, in accordance with an embodiment of the present invention. Assume in this example that a service degradation or disruption has been detected (by an end user or an automated monitoring system) with respect to application XYZ, reference numeral 202. As shown in FIG. 2, an application XYZ, reference numeral 202 is shown to have three specific resources, resource 1, reference numeral 204, resource 2, reference numeral 206 and resource 3, reference numeral 208. In particular, FIG. 2 shows the dependency information for the application XYZ and the three resources 1, 2 and 3 (reference numerals, 202, 204 and 206). In FIG. 2, an arrows points in the direction of a dependency, thus, the arrow 203 pointing toward resource 1 (204) indicates that the application XYZ depends on resource 1 (reference numeral 204) and, further, the arrow 205 indicates that the application XYZ depends on resource 2 (reference numeral 206). Furthermore, the arrow 207 indicates that resource 1 (reference numeral 204) depends on resource 3 (reference numeral 208). Also, as shown in FIG. 2, resource 1 has been classified or typed (resource type) as a web server, whereas, resource 2 has been classified or typed as a print server, and resource 3 has been identified as a transaction server. As such, if the application XYZ (reference numeral 202) is experiencing a resource or service degradation at a given point-in-time where all three resources 1, 2 and 3 are reporting a status of warning, but where resource 3 (reference numeral 208) is the problem for failing resource, the correlation rules or logic in the dynamic correlation logic tool would be able to process the set of configuration data shown in FIG. 2 to identify or determine which resource or resources in the point-in-time model 200 are the failing components. Using the correlation logic or logic or rules in the dynamic correlation logic tool would provide the ability to interrogate and correlate the resource and relationship information provided in the configuration management database and would be able to inform an administrator or user that based upon the correlation performed that resource 3 (reference numeral 208) is contributing to the resource or service degradation at the given point-in-time. For example, it is determined that resource 1 (reference numeral 204) is impacting Application XYZ (reference numeral 202) availability, but that resource 1 (reference numeral 204) depends on Resource 3 (208), which is also currently experiencing availability problems. The method outlined herein above would help determine that addressing problems with resource 3 (reference numeral 208) could resolve resource 1 problems and restore application XYZ, thus, not wasting any time or effort on addressing resource 2 issues at that point-in-time. For instance, the correlation logic would able to provide an X % certainty in identifying a resource or component, for instance, an 80% certainty rate that resource 3 (reference numeral 208) is contributing to the resource or service degradation at the given point-in-time. Without the dynamic correlation logic tool, there is no ability to interrogate and correlate the resource and relationship information quickly and, as such, efforts to restore service may be directed to the incorrect resources, resource 1 (reference numeral 204) or resource 2 (reference numeral 206).

Accordingly, the method of dynamically identifying the actual failing component or components is logic invoked, passing as input, application XYZ (reference numeral 202) as the starting point for the analysis. The processing involved in the identification of the actual failing component logic is to look at each object in the model (where each object represents a resource or relationship) and to examine the object in order to determine what type (class) of resource the object represents, what is the relationship of the resource to the other resources, a current status of the object as obtained from a monitoring system or source for the object and additional attributes for the resource and/or relationships. With respect to determining the type (class) of resource, there are certain types of resources that are more important to the functioning of the service than others. For example, a web server may be more important that a print server. Further, different relationships among the resources can be weighted to reflect importance and may additionally also be associated with the type of resource. The status obtained from the monitoring system or systems may include relationship status that may be relevant in identifying the component or resource contributing to a resource or service degradation at a given point-in-time. Moreover, additional attributes from the object, such as, last change date or other customized attributes are gathered as defined. The set of information is then processed together to determine the failing component.

Accordingly, when a condition is detected or when there is degradation in performance or availability, the dynamic correlation logic tool is run, such that the point-in-time model 130 is built or created dynamically using the configuration data (the resources, relationships) in the configuration management database 120 at that particular point-in-time, plus the status received for each object shown in FIG. 2 from each monitoring source for that object, plus any additional attributes for the resource and/or relationship as described herein. So for example, if the configuration management database provides a configuration data for an environment where resource A is dependent on resource B and where resource B is dependent on resource C, then if the environment changes to include another resource D, which gets updated in the configuration management database, this change would be picked up automatically the next time the dynamic correlation logic tool is run. Thus, the configuration management database has the updated configuration data, so when the dynamic correlation logic tool is run, it picks up any updated configuration information in its analysis to identify a component or components contributing to the resource or service degradation at the given point-in-time.

Reference is now made to FIG. 3, which illustrates an embodiment of a system for dynamically identifying one or more resources or components contributing to a resource or service degradation at a given point-in-time, in accordance with an embodiment of the present invention. Turning to FIG. 3, FIG. 3 is a schematic block system diagram illustrating one embodiment of a system or server 300 having a dynamic correlation logic tool or component 320 deployed thereon. In an embodiment, the dynamic correlation logic tool 320 is configured to dynamically identify one or more resources or components contributing to a resource or service degradation at a given point-in-time. Preferably, the computer system 300 is a server, for instance, an application server that is dedicated to run software application(s) 312 and uses the dynamic correlation logic tool 320, deployed thereon, to dynamically identify one or more resources or components contributing to a resource or service degradation at a given point-in-time. The computer system 300 includes a central processing unit (CPU) 304, a local storage device 302, a user and/or administrator interface 306, a network interface 308, and a memory 31O. The CPU 304 is configured generally to execute operations within the system or server 300. The user interface 306, in one embodiment, is configured to allow a user and/or administrator to interact with the system 300, including allowing input data and commands from a user and/or administrator. The network interface 308 is configured, in one embodiment, to facilitate network communications of the system 300 over a communications channel of a network (not shown in any of the drawings). In an embodiment, the local memory 310 is configured to store one or more application(s) or program(s) 312 that are run on the system 300. Further, the memory 310 is configured, in an embodiment, to store the point-in-time model 314, which is created or built by the dynamic correlation logic tool 320 using the configuration data obtained from the configuration management database (CMDB) 316 that is stored in a storage system 302. Alternatively, it is understood that the configuration management database (CMDB) 316 may be stored in a separate storage external to the server 300.

In one embodiment, as shown in FIG. 3, the dynamic correlation logic tool 320 which runs on the server or system 300 comprises a logic unit that contains a plurality of modules configured to functionally execute the necessary steps of dynamically identifying one or more resources or components contributing to a resource or service degradation experienced by an application at a given point-in-time. In particular, the dynamic correlation logic tool 320 includes a data module 322, a status module 324, a correlation logic module 326, an evaluation module 328, a reporting module 330 and a communications module 332. The data module 322 of the dynamic correlation logic tool 320 is configured to obtain a set of configuration data from the configuration management database (CMDB) 316, stored in storage system 302. The status module 324 is configured to obtain the current status of one or more resources from one or more external monitoring sources or systems (not shown in FIG. 3), as needed by the dynamic correlation logic tool 320. Further, the correlation logic module 326 is configured to build the point-in-time model 312 (shown in memory 310) for an application experiencing service degradation at a given point-in-time due to a resource, utilizing the information gathered by the data module 322 and the status module 324. The evaluation module 328 is configured to evaluate and/or analyze the point-in-time model 314 (stored in local memory 310) that is built or created using the configuration data obtained from the CMDB 316 and the status information gathered from external monitoring systems or sources, and which point-in-time model 314 is evaluated and/or analyzed using the correlation logic module 326 in order to identify the resource or resources causing the service degradation at a point-in-time for an application. Moreover, the reporting module 330 is configured to report the results of an identified component or components, for instance, to an administrator, such that, the administrator can take appropriate action(s) with respect to the identified component or components to eliminate or minimize the resource or service degradation. Further, the communications module 332 is configured to permit communication between the various modules of the dynamic correlation logic tool 320 and the various components, such as, the configuration management database 316 stored in the database 302, the point-in-time model 312 stored in the memory 310 and the various monitoring system(s) from which the dynamic correlation logic tool 320 acquires status data.

In yet another embodiment, the invention provides a computer program product for dynamically identifying one or more resources or components contributing to a resource or service degradation experienced by an application at a given point-in-time. Preferably, the computer program product comprises a form accessible from the computer-usable or computer-readable medium, which provides program codes or instructions for use by or in connection with a computer or any instruction execution system. For the purposes of this description, a computer-usable or computer readable medium can be any apparatus that can contain, store, communicate, propagate, or transport the codes or instructions for use by or in connection with the instruction execution system, apparatus, or device. Preferably, the medium can include an electronic, magnetic, optical, electromagnetic, infrared, or semiconductor system (or apparatus or device) or a propagation medium. More preferably, the computer-readable medium can include a semiconductor or solid state memory, magnetic tape, a removable computer diskette, a random access memory (RAM), a read-only memory (ROM), a rigid magnetic disk and an optical disk. Further, examples of optical disks include compact disc—read only memory (CD-ROM), compact disc—read/write (CD-R/W) and digital versatile/video disc (DVD). The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The computer program product further comprises first program instructions to obtain from a configuration management database a set of configuration data for one or more resources utilized by an application experiencing a service degradation at a given point-in-time. The computer program product further includes second program instructions to dynamically build a point-in-time model using the set of configuration data obtained from the configuration management database and status data obtained from one or more monitoring sources configured to monitor the one or more resources and third program instructions to evaluate the point-in-time model to identify the one or more resources utilized by the application contributing to the service degradation at the given point-in-time. In an embodiment, the first program instructions further include instructions to provide the configuration management database configured to store therein the set of configuration data for the one or more resources utilized by the application and configured to update the set of configuration data stored therein on a predetermined basis, such that the set of configuration data for the one or more resources utilized by the application experiencing the service degradation at the given point-in-time stored in the configuration management database includes an up-to-date set of configuration data. Further, in an embodiment, the second program instructions include instructions to acquire from the one or more monitoring sources, as needed, a current status for the one or more resources utilized by the application to dynamically build the point-in-time model. Furthermore, the second program instructions include instructions to dynamically build the point-in-time model using the up-to-date set of configuration data obtained from the configuration management database and the current status acquired for the one or more resources from the one or more monitoring sources. In an embodiment, the third program instructions include instructions to report the one or more resources identified, such that, an appropriate action can be taken with respect to the one or more resources contributing to the service degradation at the given point-in-time. In an embodiment, the set of configuration data includes one or more of: types of resources, resource relationships, types of relationships, attributes for each resource and attributes for each relationship. Preferably, each of the first, second and third program instructions are stored on the computer readable medium.

Referring now to FIG. 4, there is illustrated a system 400 for dynamically identifying one or more resources or components contributing to a resource or service degradation experienced by an application at a given point-in-time. As depicted, system 400 includes a computer infrastructure 402, which is intended to represent any type of computer architecture that is maintained in a secure environment (i.e., for which access control is enforced). As shown, infrastructure 402 includes a computer system 404 that typically represents a server or the like. It should be understood, however, that although not shown, other hardware and software components (e.g., additional computer systems, such as, routers, firewalls, etc.) could be included in infrastructure 402.

In general, an application (such as, application 1, reference numeral 430 through application X, reference numeral 432) may interface with infrastructure 402 for utilizing one or more resources connected to the infrastructure 402, such as resource 1, reference numeral 442 through resource X, reference numeral 444. Further, as shown, one or more monitoring system(s) or monitoring source(s) 440 can interface with infrastructure 402. Similarly, an administrator 434 can interface with infrastructure 402 for supporting and/or configuring the infrastructure 402, such as, upgrading the dynamic correlation logic tool 414. In general, the parties could access infrastructure 402 directly, or over a network via interfaces (e.g., client web browsers) loaded on computerized devices (e.g., personal computers, laptops, handheld devices, etc.). In the case of the latter, the network can be any type of network such as the Internet or can be any other network, such as, a local area network (LAN), a wide area network (WAN), a virtual private network (VPN), etc. In any event, communication with infrastructure 402 could occur via a direct hardwired connection (e.g., serial port), or via an addressable connection that may utilize any combination of wire line and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to infrastructure 402. It should be understood that under the present invention, infrastructure 402 could be owned and/or operated by a party, such as, a provider 446, or by an independent entity. Regardless, use of infrastructure 402 and the teachings described herein could be offered to the parties on a subscription or fee-basis. In either scenario, an administrator 434 could support and configure infrastructure 402, as mentioned herein above.

Computer system or server 404 is shown to include a CPU (hereinafter “processing unit 406”), a memory 412, a bus 410, and input/output (I/O) interfaces 408. Further, computer system 400 is shown in communication with external I/O devices/resources 424 and storage system 422. In an embodiment as shown, the storage system 422 has stored therein the configuration management database (CMDB) 426 that provides the set of configuration data for the one or more resources utilized by an application that is experiencing a resource or service degradation at a given point-in-time. In general, processing unit 406 executes computer program codes, such as, the dynamic correlation logic tool 414, which is configured to dynamically build a point-in-time model 416 using the set of configuration data obtained from the configuration management database (CMDB) 426 and using status information for the one or more resources 1 through X (reference numeral 442 through 44) obtained from one or more monitoring systems 440 that are configured to monitor the one or more resources (1 through X) that may be utilized by an application 1 through X that is experiencing resource or service degradation. While executing the dynamic correlation logic tool 414, the processing unit 406 can read and/or write data, to/from memory 412, storage systems 422, and/or I/O interfaces 408. Bus 410 provides a communication link between each of the components in computer system 400. External devices 424 can include any devices (e.g., keyboard, pointing device, display, etc.) that enable a user to interact with computer system 400 and/or any devices (e.g., network card, modem, etc.) that enable computer system 400 to communicate with one or more other computing devices.

Computer infrastructure 402 is only illustrative of various types of computer infrastructures for implementing the invention. For example, in one embodiment, computer infrastructure 402 includes two or more computing devices (e.g., a server cluster) that communicate over a network to perform the various process steps of the invention. Moreover, computer system 400 is only representative of various possible computer systems that can include numerous combinations of hardware. To this extent, in other embodiments, computer system 400 can include any specific purpose computing article of manufacture comprising hardware and/or computer program code for performing specific functions, any computing article of manufacture that includes a combination of specific purpose and general purpose hardware/software, or the like. In each case, the program code and hardware can be created using standard programming and engineering techniques, respectively. Moreover, processing unit 406 may include a single processing unit, or be distributed across one or more processing units in one or more locations, e.g., on a client and server. Similarly, memory 412 and/or storage system 422 can include any combination of various types of data storage and/or transmission media that reside at one or more physical locations. Further, I/O interfaces 408 can include any system for exchanging information with one or more external devices 424. Still further, it is understood that one or more additional components (e.g., system software, math co-processing unit, etc., not shown in FIG. 4) can be included in computer system 400. Similarly, it is understood that the one or more external devices 424 (e.g., a display) and/or storage system 422 could be contained within computer system 404, and not externally as shown.

Storage system 422 can be any type of system (e.g., a database) capable of storing and/or updating information or configuration data, such as, the configuration management database (CMDB) 426. To this extent, storage system 422 could include one or more storage devices, such as a magnetic disk drive or an optical disk drive. In another embodiment, storage system 422 includes data distributed across, for example, a local area network (LAN), wide area network (WAN) or a storage area network (SAN) (not shown). Although not shown, additional components, such as cache memory, communication systems, system software, etc., may be incorporated into computer system 400.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of dynamically identifying one or more components contributing to a service degradation at a given point-in-time, said method comprising the steps of:
obtaining from a configuration management database a set of configuration data for one or more components utilized by an application experiencing a service degradation at a given point-in-time;
dynamically building a model for said application using said set of configuration data obtained from said configuration management database and status data obtained from one or more monitoring sources configured to monitor said one or more components;
evaluating said model using logic; and
identifying said one or more components utilized by said application contributing to said service degradation at said given point-in-time.

2. The method according to claim 1, wherein said obtaining step further comprises the steps of:
providing said configuration management database configured to store therein said set of configuration data for said one or more components utilized by said application.

3. The method according to claim 2, wherein said dynamically building step further comprises the step of:
providing a dynamic correlation logic tool having said logic that is configured to dynamically build said model for said application experiencing service degradation and to analyze said model using said logic.

4. The method according to claim 3, wherein said dynamically building step further comprises the step of:
acquiring from said one or more monitoring sources a current status for one or more of said components utilized by said application for dynamically building said model.

5. The method according to claim 4, wherein said obtaining step further comprises the step of:
providing said configuration management database configured to update said set of configuration data stored therein on a predetermined basis, such that said set of configuration data for said one or more components utilized by said application experiencing said service degradation at said given point-in-time obtained by said dynamic correlation logic tool is an up-to-date set of configuration data.

6. The method according to claim 5, wherein said acquiring step further includes the step of:
determining said one or more monitoring sources configured to monitor said one or more components that are utilized by said application experiencing said service degradation at said given point-in-time.

7. The method according to claim 6, wherein said identifying step further comprises the step of:
reporting said one or more components identified, such that, an appropriate action can be taken with respect to said one or more components contributing to said service degradation at said given point-in-time.

8. The method according to claim 7, wherein said set of configuration data comprises one or more of: types of components, component relationships, types of relationships, attributes for each component and attributes for each relationship.

9. A system for dynamically identifying one or more resources contributing to a service degradation at a given point-in-time, comprising:
an application experiencing a service degradation at a given point-in-time, said application utilizing one or more resources;
a configuration management database configured to store therein a set of configuration data for said one or more resources utilized by said application; and
a dynamic correlation logic tool having logic, said dynamic correlation logic tool being configured to dynamically build a model using said set of configuration data obtained from said configuration management database and using status information for said one or more resources obtained from one or more monitoring systems configured to monitor said one or more resources utilized by said application experiencing said service degradation at said given point-in-time and is configured to analyze said model using said logic to dynamically identify said one or more resources contributing to said service degradation at said given point-in-time, such that, appropriate action can be taken with respect to said one or more resources identified.

10. The system according to claim 9, wherein said dynamic correlation logic tool is further configured to obtain from said one or more monitoring systems, as needed, a current status for said one or more resources in order to build said model.

11. The system according to claim 10, wherein said configuration management database is further configured to update on a predetermined basis said set of configuration data for said one or more resources utilized by said application stored therein.

12. The system according to claim 11, wherein said dynamic correlation logic tool is further configured to use said set of configuration data that is updated in said configuration management database, such that said set of configuration data used by said dynamic correlation logic tool to build said model is an up-to-date set of configuration data.

13. The system according to claim 12, wherein said dynamic correlation logic tool is further configured to dynamically build said model using said up-to-date set of configuration data obtained from said configuration management database and said current status for said one or more resources obtained from said one or more monitoring systems.

14. The system according to claim 13, wherein said set of configuration data comprises one or more of: types of resources, resource relationships, types of relationships, attributes for each resource and attributes for each relationship.

15. A computer program product for dynamically identifying one or more resources contributing to a service degradation at a given point-in-time, said computer program product comprising:
a computer readable medium;
first program instructions to obtain from a configuration management database a set of configuration data for one or more resources utilized by an application experiencing a service degradation at a given point-in-time;
second program instructions to dynamically build a model using said set of configuration data obtained from said configuration management database and status data obtained from one or more monitoring sources configured to monitor said one or more resources;
third program instructions to evaluate said model to identify said one or more resources utilized by said application contributing to said service degradation at said given point-in-time; and wherein said first, second and third program instructions are stored on said computer readable medium.

16. The computer program product according to claim 15, wherein said first program instructions further comprise instructions to provide said configuration management database configured to store therein said set of configuration data for said one or more resources utilized by said application and configured to update said set of configuration data stored therein on a predetermined basis, such that said set of configuration data for said application stored in said configuration management database comprises an up-to-date set of configuration data.

17. The computer program product according to claim 16, wherein said second program instructions further comprise instructions to acquire from said one or more monitoring sources, as needed, a current status for said one or more resources utilized by said application to dynamically build said model.

18. The computer program product according to claim 17, wherein said second program instructions further comprise instructions to dynamically build said model using said up-to-date set of configuration data obtained from said configuration management database and said current status acquired for said one or more resources from said one or more monitoring sources.

19. The computer program product according to claim 18, wherein said third program instructions further comprise instructions to report said one or more resources identified, such that, an appropriate action can be taken with respect to said one or more resources contributing to said service degradation at said given point-in-time.

20. The computer program product according to claim 19, wherein said set of configuration data comprises one or more of: types of resources, resource relationships, types of relationships, attributes for each resource and attributes for each relationship.
